(19) United States
(12) Patent Application Publication
(10) Pub. No.: US 2017/0002639 A1
(43) Pub. Date: Jan. 5, 2017

(54) THREE-DIMENSIONAL MULTI-LAYERED VISUALIZATION FOR FLUID TREATMENT DESIGN AND ANALYSIS

(71) Applicant: Halliburton Energy Services, Inc., Houston, TX (US)

(72) Inventors: Ashish Sudhir Thakar, Pune (IN); Ghanshyam Yadav, Pune (IN); Pradeep Agrawal, Pune (IN); Dheeraj Dilip Awale, Pune (IN); Vishal Vinayak Harne, Pune (IN); Jogesh Birtharia, Pune (IN); Ashish Dayal, Lucknow (IN)

(21) Appl. No.: 14/789,393

(22) Filed: Jul. 1, 2015

(51) Int. Cl. E21B 43/30; G06F 17/50; E21B 41/00

(52) U.S. Cl. CPC E21B 43/30; E21B 41/0092; G06F 17/5009

(57) ABSTRACT

System and methods for fluid treatment design and analysis are provided. Data for treatment parameters associated with a multistage fluid treatment design are obtained, based on at least one design criterion selected from a plurality of design criteria affecting the multistage fluid treatment design. A relative index value is determined for each of the treatment parameters with respect to the selected design criterion at each stage of the multistage fluid treatment design. Values are assigned to one or more visualization parameters for indicating a relative impact of each of the treatment parameters with respect to the selected design criterion at each stage, based on the relative index value corresponding to each treatment parameter. A three-dimensional (3D) graphical representation of the multistage fluid treatment design is generated and provided for display via a graphical user interface (GUI) of a client application executable at a computing device of a user.

### FIELD OF THE DISCLOSURE

The present disclosure relates generally to downhole fluid treatment design and analysis tools.

### BACKGROUND

As the oil or natural gas in a formation is produced, the hydrocarbons remaining in the reservoir may become trapped because the pressure in the formation has decreased, making production either slow dramatically or stop altogether. Hydraulic fracturing is a stimulation technique for increasing production from the well by pumping a fracturing fluid, typically water with selected additives, into a completed well under high pressure. The high pressure fluid causes fractures to form and propagate within the surrounding geological formation, making it easier for formation fluids to reach the wellbore. After the fracturing is complete, the pressure is reduced, allowing most of the fracturing fluid to flow back into the well. Some residual amount of the fracturing fluid may be expected to remain in the surrounding formation and perhaps flow back to the well over time as other fluids are produced from the formation.

In addition to or as part of hydraulic fracturing processes, stimulation treatments may be considered. In the stimulation planning process (e.g., for fracturing treatments or matrix acidizing treatments), the goal is to determine the appropriate fluids, and the attributes of those fluids, for optimal stimulation of a wellbore. Costs of treatments also may be taken into account. During the stimulation planning process, multiple treatment stages, stage types, and fluids may be considered. Stage types, stage fluids, volumes, or other parameters, may be determined manually, or may result from a recommendation engine or algorithm. In either case, the resulting fluid selection information may be displayed for viewing and evaluation.

Applications used in the design of fluid treatments may present information, such as treatment fluid type, stage type, stage data, etc., in various forms, for example, as a table or two-dimensional (2D) graph of selected options for a treatment plan. However, such 2D presentations of information may be difficult to use, particularly for complex fluid treatment designs involving multiple fluid types and properties that need to be considered with a number of other factors to plan an effective downhole treatment for a particular formation.

### BRIEF DESCRIPTION OF THE DRAWINGS

FIG. 1 is a block diagram of an exemplary computer system for the design and analysis of downhole fluid treatments for stimulating hydrocarbon production from a subsurface reservoir formation, according to an embodiment of the present disclosure.

FIG. 2 is an exemplary graphical user interface (GUI) for enabling downhole fluid treatment design and analysis at a user's computing device.

FIG. 3 is an exemplary 3D multi-layered visualization that may be presented to the user via the GUI of FIG. 2.

FIGS. 4A and 4B are examples of 3D single-layered visualizations that also may be presented to the user via the GUI of FIG. 2.

FIG. 5 is a process flowchart of an exemplary method of aiding fluid treatment design and analysis.

FIG. 6 is a view of an exemplary design workspace including multiple design frames for creating and analyzing different fluid models for a fluid treatment design.

FIG. 7 is a process flowchart of an exemplary user workflow for creating and visualizing a new fluid model within a frame of the design workspace of FIG. 6.

FIG. 8 is a view of an exemplary fluid selection panel for selecting fluids to be included within the fluid model being created via the user workflow of FIG. 7.

FIG. 9 is view of an exemplary fluid calibration panel for configuring or calibrating the selected fluids and related properties for the fluid model being created via the user workflow of FIG. 7.

FIG. 10 is a view of an exemplary proppant selection panel for selecting proppants to be associated with the selected fluids of the fluid model being created via the user workflow of FIG. 7.

FIG. 11 is a view of an exemplary flow model selection panel for selecting a particular type of flow model to be applied to each of the selected fluids of the fluid model being created via the user workflow of FIG. 7.

FIG. 12 is a view of an exemplary visualization options panel for configuring different options for visualizing flow characteristics calculated for the fluid model created via the user workflow of FIG. 7.

FIG. 13 is a view of the design workspace of FIG. 6 in which the flow characteristics for different fluid models created via the user workflow of FIG. 7 are visualized within selected frames of the design workspace.

FIG. 14 is a block diagram of an exemplary computer system in which embodiments of the present disclosure may be implemented.

### DESCRIPTION OF ILLUSTRATIVE EMBODIMENTS

Embodiments of the present disclosure relate to three-dimensional (3D) visualization of fluid treatment parameters for downhole fluid treatment design and planning. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility. Further, when a particular feature, structure, or characteristic is described in connection with an embodiment, it is submitted that it is within the knowledge of one skilled in the relevant art to effect such feature, structure, or characteristic in connection with other embodiments whether or not explicitly described.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The disclosure may repeat reference numerals and/or letters in the various examples or Figures. This repetition is for the purpose of simplicity and clarity and does not in itself dictate a relationship between the various embodiments and/or configurations discussed. Further, spatially relative terms, such as beneath, below, lower, above, upper, uphole, downhole, upstream, downstream, and the like, may be used herein for ease of description to describe one element or feature's relationship to another element(s) or feature(s) as illustrated, the upward direction being toward the top of the corresponding figure and the downward direction being toward the bottom of the corresponding figure, the uphole direction being toward the surface of the wellbore, the downhole direction being toward the toe of the wellbore. Unless otherwise stated, the spatially relative terms are intended to encompass different orientations of the apparatus in use or operation in addition to the orientation depicted in the Figures. For example, if an apparatus in the Figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Moreover even though a Figure may depict a horizontal wellbore or a vertical wellbore, unless indicated otherwise, it should be understood by those skilled in the art that the apparatus according to the present disclosure is equally well suited for use in wellbores having other orientations including vertical wellbores, slanted wellbores, multilateral wellbores or the like. Likewise, unless otherwise noted, even though a Figure may depict an onshore operation, it should be understood by those skilled in the art that embodiments of the present disclosure are not intended to be limited thereto and that the disclosed embodiments may be equally well suited for use in an offshore operation. Further, unless otherwise noted, even though a Figure may depict a cased hole, it should be understood by those skilled in the art that the disclosed embodiments may be equally well suited for use in open hole operations.

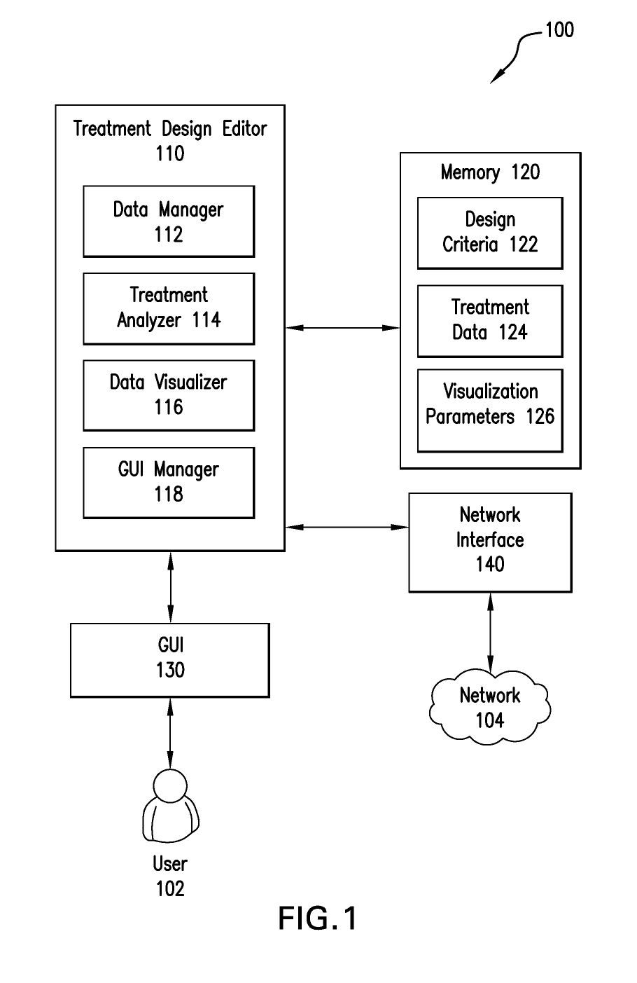

Illustrative embodiments and related methodologies of the present disclosure are described below in reference to FIGS. 1-14 as they might be employed, for example, in a computer system for the design and analysis of a downhole fluid treatment, e.g., a matrix acidizing treatment, including multiple stages for stimulating hydrocarbon production from an underground reservoir formation. In one example, a reservoir engineer may design such a multistage fluid treatment based on various criteria related to different aspects of the treatment and type of stimulation treatment that may be used. For example, the criteria for a fluid treatment plan for stimulation through multistage hydraulic fracturing may involve designing not only the type and quantity of fluids, additives and proppants to be used for the treatment but also the type and number of stages for the stimulation. The total cost and environmental impact of the treatment are additional factors that may need to be taken into account for an effective treatment design.

As will be described in further detail below, embodiments of the present disclosure provide a capability for visualizing a 3D graphical representation of a fluid treatment design with respect to one or more selected design criteria. Examples of design criteria that may be considered for a fluid treatment design include, but are not limited to, a treatment fluids index, an economic index, an additive index, and an environmental index. In an embodiment, such a 3D graphical representation may include a representation of various treatment parameters at each stage of the treatment across multiple layers corresponding to different design criteria selected for consideration in the fluid treatment design. This would allow a user to view multiple design criteria for a multistage fluid treatment design simultaneously, thereby facilitating downhole fluid treatment design and analysis.

In an embodiment, such a 3D multi-layer representation of the treatment design may be presented to the user via, for example, a graphical user interface (GUI) of a fluid treatment design editor application. Advantages of the present disclosure may include, but are not limited to, enabling improved design and analysis of a fluid treatment design with respect to one or multiple design criteria or factors selected for consideration in the treatment design. Such a capability would help to reduce design time and improve the effectiveness of the fluid treatment design overall. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

FIG. 1 is a block diagram of an exemplary computer system 100 for the design and analysis of downhole fluid treatments for stimulating hydrocarbon production from a subsurface reservoir formation. As shown in FIG. 1, system 100 includes a treatment design editor 110, a memory 120, a GUI 130, and a network interface 140. Design editor 110 includes a data manager 112, a treatment analyzer 114, a data visualizer 116 and a GUI manager 118.

Memory 120 may be used to store various types of information accessible to design editor 110 for implementing the downhole fluid treatment design functionality described herein. As shown in FIG. 1, such information may include, but is not limited to, design criteria 122, treatment data 124 and visualization parameters 126. Memory 120 can be any type of recording medium coupled to an integrated circuit that controls access to the recording medium. The recording medium can be, for example and without limitation, a semiconductor memory, a hard disk, or other similar type of memory or storage device. It should be noted that memory 120 may be integrated within system 100 or an external device communicatively coupled to system 100. In some implementations, memory 120 may be a remote cloud-based storage location communicatively coupled to system 100 over a network 104 via network interface 140.

Network 104 can be any type of network or combination of networks used to communicate information between different computing devices. Network 104 can include, but is not limited to, a wired (e.g., Ethernet) or a wireless (e.g., Wi-Fi and 3G) network. In addition, network 104 can include, but is not limited to, a local area network, medium area network, and/or wide area network such as the Internet.

Embodiments of design editor 110, including data manager 112, treatment analyzer 114, data visualizer 116 and GUI manager 118, or portions thereof, can be implemented to run on any type of processing device including, but not limited to, a computer, workstation, embedded system, networked device, mobile device, or other type of processor or computer system capable of carrying out the functionality described herein. Thus, system 100 can be implemented using any type of computing device having one or more processors, a user input (for example, a mouse, QWERTY keyboard, touch-screen, a graphics tablet, or microphone), and a communications infrastructure capable of receiving and transmitting data over a network. Such a computing device can be, for example and without limitation, a mobile phone, a personal digital assistant (PDA), a smartphone, a tablet computer, a laptop computer, a desktop computer, a workstation, a cluster of computers, a set-top box, or other similar type of device capable of processing instructions and receiving and transmitting data to and from humans and other computing devices.

In an embodiment, design editor 110 and its components (data manager 112, treatment analyzer 114, data visualizer 116 and GUI manager 118), memory 120, GUI 130, and network interface 140 may be communicatively coupled to one another via, for example, an internal data bus of system 100. Although only design editor 110, memory 120, GUI 130, and network interface 140 are shown in FIG. 1, it should be appreciated that system 100 may include additional components, modules, and/or sub-components, as needed or desired for a particular implementation. It should also be appreciated that design editor 110 and its components (data manager 112, treatment analyzer 114, data visualizer 116 and GUI manager 118), can be implemented in software, firmware, hardware, or any combination thereof.

As will be described in further detail below, design editor 110 may use GUI 130 to present different types of information related to a downhole fluid treatment design for a user 102 to view on a display (not shown) coupled to system 100. The display may be, for example and without limitation, a cathode ray tube (CRT) monitor, a liquid crystal display (LCD), or a touch-screen display, e.g., in the form of a capacitive touch-screen light emitting diode (LED) display. The information presented by design editor 110 within GUI 130 may be based at least partly on the user's interactions with GUI 130 via a user input device (not shown), e.g., a mouse, keyboard, microphone, or touch-screen display. In an embodiment, treatment design editor 110 and GUI 130 may be associated with a fluid treatment design application executable at a computing device of user 102. For example, GUI 130 may be provided by the fluid treatment design application for user 102 to view on a display coupled to the computing device.

In some implementations, such a treatment design application may be a client application associated with a web service for providing fluid treatment design and analysis functionality at the computing device of user 102. For example, the web service may be hosted at a remote server and client application may communicate with the web service via network 104 for purposes of obtaining data related to various treatment parameters for one or more design criteria/factors selected for consideration in a fluid treatment design, as will be described in further detail below. In an embodiment, the server may be coupled to a database or central repository of information related to different fluids, additives and other relevant materials that may be used in different fluid treatments. Such a materials database may be referred to herein as a “material library.” Further, the web service may be part of a material library application for providing remote access to the material library information for purposes of fluid treatment design and analysis.

In an embodiment, GUI manager 118 may receive input from user 102 based on the user's interactions with GUI 130 for a downhole fluid treatment currently being designed by user 102. The input from user 102 may include, for example, an indication of the particular type of fluid treatment being designed. The indication of the type of fluid treatment may be based on, for example, the selection by user 102 of a type of fluid treatment from a list of different treatment types displayed within GUI 130, e.g., within a dropdown menu, a popup list, or other type of selection control element. Examples of different types of fluid treatments include, but are not limited to, hydraulic fracturing, acid fracturing and acid matrix stimulation.

In an embodiment, GUI manager 118 may retrieve from memory 120 appropriate design factors or design criteria 122 to be displayed within GUI 130 for the particular type of fluid treatment design selected by user 102. For example, each type of fluid treatment may be associated with a set of design criteria/factors based on its intended purpose or use and the particular type of formation for which it is generally used to stimulate hydrocarbon production or recovery. However, it should be appreciated that the selection of a fluid type may be optional and that GUI manager 118 may display a default list of design criteria/factors applicable to any fluid treatment regardless of its type.

In an embodiment, the list of design criteria may be displayed by GUI manager 118 within a portion of GUI 130, e.g., a dedicated criteria selection area, which is separate from the visualization of the fluid treatment design, as will be described in further detail below. Such a criteria selection portion of GUI 130 may be used to present the design criteria as a list of options that user 102 may select as desired for the fluid treatment design, e.g., by using a mouse or other user input device to select a corresponding checkbox or other type of UI control element displayed within the criteria selection portion of GUI 130 for each of one or more criteria of interest.

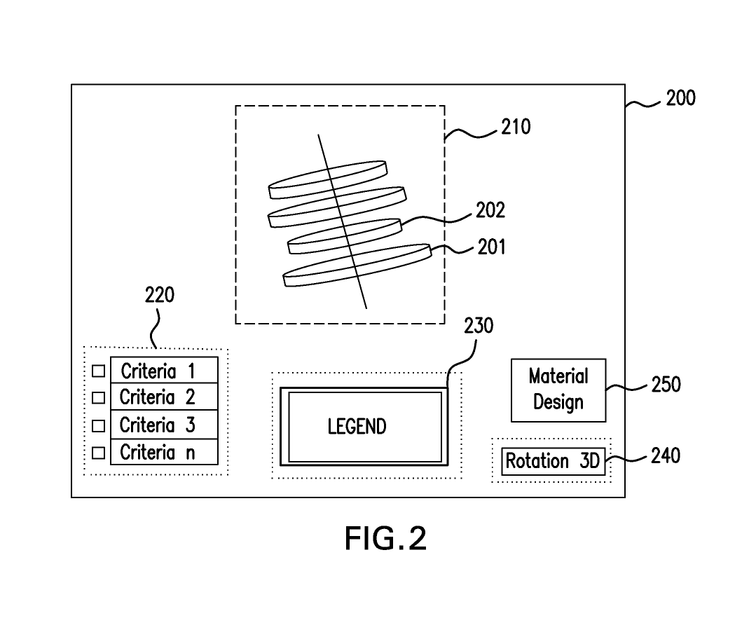

In an embodiment, data manager 112 may obtain treatment data 124 from memory 120 for various treatment parameters associated with at least one design factor selected by user 102 from a plurality of design factors for consideration in the fluid treatment design. The plurality of design factors may displayed as a list of selectable options within a portion of GUI 130, as described above. In one example, the fluid treatment design may be a multistage fluid treatment design including multiple treatment stages, stage types, and fluids. Accordingly, treatment data 124 may include, but is not limited to, different types of data related to the stage types, stage fluids, fluid volumes and associated properties of the fluid treatment design. Examples of treatment parameters that may be associated with different design factors will be described in further detail below with respect to FIGS. 2-4B. Also, as will be described in further detail below, the data related to the treatment parameters associated with a particular design factor selected for consideration in the fluid treatment design may be obtained from any of various data sources, as would be appropriate given the particular design factor that is selected.

In an embodiment, treatment data 124 may include downhole environment information obtained from a wellbore drilled into the subsurface reservoir formation targeted for stimulation in this example. The downhole environment information may include, for example, downhole measurements of different formation properties. Such formation property measurements may be collected using any of various downhole instrumentation devices, sensors or tools including, but not limited to, one or more measurement-while-drilling (“MWD”) or logging-while-drilling (“LWD”) tools. However, it should be appreciated that in some cases, the formation properties described herein may be estimated based on reservoir formation data obtained from any of various other data sources including, but not limited to, well tests, core analyses, relevant publications or public records, drilling records, production records and completion records.

The wellbore in the above example may be either an existing wellbore to be used for the stimulation treatment or a planned wellbore to be drilled at a predetermined location on the surface of the targeted reservoir formation. Thus, in the case of a planned wellbore, measurements of formation properties obtained from an offset well may be used in place of actual formation property measurements at the projected site of the planned wellbore or for estimating the formation properties with respect to the planned wellbore. In addition to reservoir data, such as formation property measurements, downhole environment information that may be relevant to the current fluid treatment design may include wellbore data, which along with the reservoir data may be obtained as part of wellsite data from the wellsite, as will be described in further detail below.

In an embodiment, treatment design editor 110 may provide a wellsite data interface that operates to receive or retrieve wellsite data including, for example, the above-described downhole environment information. The wellsite data in this example may be obtained periodically or upon request via network interface 140 and network 104, e.g., from a data processing system located at the surface of the wellsite and configured to communicate with treatment design editor 110 via network 104. For a planned wellsite, such data may be obtained, for example, from a computing device of a network data system associated with a wellsite operator. Alternatively, such data may be entered by user 102 via the wellsite data interface. This interface may be provided as a part of GUI 130, e.g., within a separate interface window or panel of a main window of GUI 130.

As noted above, the wellsite data obtained by treatment design editor 110 may include wellbore data associated with the existing or planned wellsite. In some implementations, the wellsite data interface may enable user 102 to manually enter or modify certain wellbore data including, for example, the dimensions or other configurable properties of a planned wellbore. Also, as noted above, the wellsite data may include reservoir data, which may be accessible to user 102 via GUI 130 as a separate interface or as a part of the wellsite data interface. Reservoir data may include, for example, information related to various formation properties associated with different layers of the formation. Similar to the above-described wellbore data, user 102 may be able to manually enter or modify portions of the reservoir data, e.g., configurable formation layer information, via the appropriate interface provided via GUI 130.

In addition to the above-described downhole environment information, treatment design editor 110 may obtain other types of relevant information related to the fluid treatment design or selected design factor(s) under consideration. Such other information may include, for example, information for a fluid pumping schedule, which may have been selected or recommended for one or more stages of the fluid treatment design. Such pumping schedule information may be obtained from any of various data sources via network 104. In an example, such information may be received or requested from a wellsite operator associated with the existing or planned wellsite. The information may include, for example, pumping schedule instructions obtained either periodically or upon request from the wellsite operator in this example via network 104. Additionally or alternatively, the pumping schedule information may be entered by user 102, e.g., via a separate pumping schedule interface window or panel of a main window of GUI 130.

Further, information related to the costs associated with the fluid treatment design. Such cost information may include, for example, the costs of fluids, additives, proppants and other treatment parameters being considered for use in the fluid treatment design. In an embodiment, such costs may be determined for each stage or stage type of a multistage fluid treatment design and the relative cost of each treatment parameter may be visualized for purposes of evaluating the fluid treatment design with respect to an economic index, as will be described in further detail below. The economic index may be, for example, one of the design factors that can be selected for consideration in the fluid treatment design, as described above.

In an embodiment, treatment analyzer 114 may calculate or determine a relative index value or score for each of the treatment parameters associated with the selected design factor for each stage of the multistage fluid treatment design, based on the obtained treatment data 124. Based on the relative index value of each treatment parameter, data visualizer 116 may assign a value to each of one or more visualization parameters 126 associated with each treatment parameter. In an embodiment, a set of visualization parameters 126 may be defined for representing a relative impact of each treatment parameter with respect to the selected design factor at each stage of the multistage fluid treatment design.

In an embodiment, data visualizer 116 may generate a 3D visualization of the multistage fluid treatment design, based on the values assigned to the one or more visualization parameters 126. In an embodiment, the 3D visualization may include multiple layers with each layer corresponding to a different design criterion or factor selected by user 102 for consideration in the fluid treatment design. As will be described in further detail below, such a 3D multi-layered visualization may be presented by GUI manager 118 within, for example, a treatment design viewer or visualization window of GUI 130 that may be rendered to a display (not shown) of system 100. The display may be, for example and without limitation, a cathode ray tube (CRT) monitor, a liquid crystal display (LCD), or a touch-screen display, e.g., in the form of a capacitive touch-screen light emitting diode (LED) display.

An example of a 3D multi-layered visualization of a multistage fluid treatment design is illustrated in FIG. 2. In FIG. 2, an exemplary GUI 200 for downhole fluid treatment design and analysis includes a treatment design viewer 210 for displaying a 3D visualization of a fluid treatment design. GUI 200 may be associated with, for example, a fluid treatment design application executable at a computing device of a user, e.g., user 102 of FIG. 1. As shown in FIG. 2, the 3D visualization of the fluid treatment design in this example includes multiple layers corresponding to different design factors or criteria selected by the user via a criteria selection panel 220. For example, layers 201 and 202 of the graphical representation within design viewer 210 may represent criteria 1 and 2, respectively. The user in this example may use an input device (e.g., a mouse or other pointing device) coupled to the user's computing device to show or hide particular criteria by selecting or deselecting a checkbox or other control element (e.g., a radio button) provided within criteria selection panel 220 for each of the available criteria. Examples of different design factors or criteria that may be provided as selectable options within criteria selection panel 220 include, but are not limited to, a treatment fluids index, an economic index, an additives index, and an environmental or health and safety index.

While only four criteria are shown for criteria selection panel 220 in FIG. 2, it should be noted that criteria selection panel 220 may include any number of criteria. In some implementations, criteria selection panel 220 may include a scroll bar or other UI control element, which the user can select to view additional criteria that may not be currently visible within GUI 200. For example, such additional criteria may be displayed in a separate pop-up window, which may be shown alongside the main window displayed for criteria selection panel 220 within GUI 200.

Also, as shown in FIG. 2, GUI 200 may include a summary window or legend 230 for displaying a textual summary of a selected layer of the 3D visualization. Legend 230 may be used to display, for example, information related to various treatment parameters for each stage or stage type of the fluid treatment design being represented relative to the design criteria corresponding to the selected layer. In an example, the user may use a mouse or other pointing device to interact directly with the 3D visualization presented within design viewer 210 for purposes of selecting one or more layers corresponding to design criteria of interest. The information displayed in legend 230 may be updated automatically according to the particular layer(s) selected by the user.

GUI 200 may also provide the user with different viewing options for changing the way the 3D visualization is presented within design viewer 210. GUI 200 may include, for example, a 3D rotation option 240 for enabling a 360-degree rotational view of the visualized treatment design in 3D space. 3D rotation option 240 may enable the user to control the rotation and other viewing parameters (e.g., viewing angle or zoom level) of the 3D representation within design viewer 210 by using a mouse, other pointing device or other type of user input device (e.g., a keyboard).

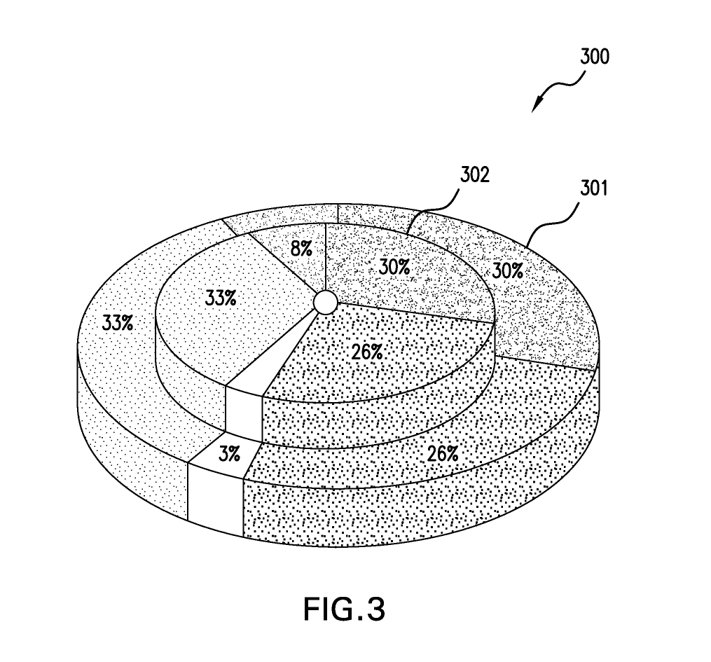

Additionally, GUI 200 may provide options for the user to change the type of 3D visualization that is presented within design viewer 210. For example, the user may be provided with an option to change the type of 3D multi-layered visualization within design viewer 210 to that shown in FIG. 3. FIG. 3 shows an exemplary 3D multi-layered visualization 300 including stacked layers 301 and 302. The option for such a stacked multi-layered visualization may be provided via GUI 200 of FIG. 2 based on, for example, the user's selection of at least two layers (e.g., layers 201 and 202) of the initial 3D multi-layered visualization presented within design viewer 210. Thus, layers 301 and 302 of visualization 300 in FIG. 3 may correspond to, for example, a stacked representation of layers 201 and 202 of the 3D multi-layered visualization in FIG. 2, as selected by the user via design viewer 210 of GUI 200. Such a stacked representation may allow the user to make better comparisons between different design criteria or factors for each stage of the multi-stage fluid treatment design.

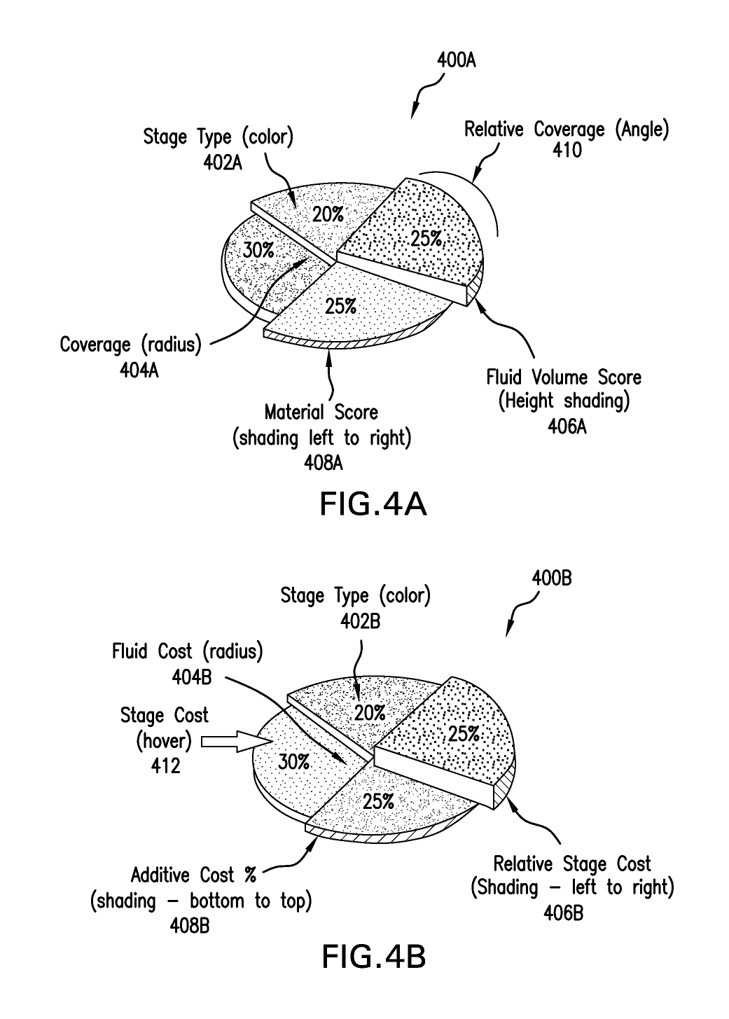

Further, GUI 200 may provide the user with an option for changing the type of 3D visualization within design viewer 210 from a 3D multi-layered visualization to a 3D single-layered visualization, as shown in each of FIGS. 4A and 4B. The visualization in each of FIGS. 4A and 4B may represent, for example, an individual design criterion of interest selected by the user via criteria selection panel 220 of GUI 200 for consideration in the multistage fluid treatment design, as described above. Thus, the visualizations shown in FIGS. 4A and 4B may correspond to different individual layers (e.g., layers 201 and 202) selected by the user from the 3D multi-layered visualization shown in design viewer 210 of GUI 200, as described above.

In the visualization examples shown in FIGS. 4A and 4B, the design criterion represented by the visualization in FIG. 4A may be a treatment fluid index, and the design criterion represented by the visualization in FIG. 4B may be an economic index. However, it should be appreciated that the embodiments of the present disclosure are not intended to be limited thereto and that the disclosed embodiments may be applied to any of various design criteria for evaluating a fluid treatment design. Also, while the visualizations in FIGS. 4A and 4B are shown in the form of 3D polar graphs or pie charts, it should be appreciated that embodiments are not intended to be limited thereto and that any of various 3D visualization techniques may be used to represent design criteria of interest for a fluid treatment design.

In FIG. 4A, an exemplary 3D single-layered visualization 400A of a multistage fluid treatment design includes a graphical representation of different treatment parameters for each stage of the multistage fluid treatment design, based on the treatment fluid index design criterion selected for consideration in the fluid treatment design. The treatment parameters for each stage in this example may include, but are not limited to, a stage type, a fluid coverage, a fluid volume index or score, a fluid material index/score and a relative coverage of the treatment overall. The term “coverage” as used herein refers to the amount or volume of treatment fluid to be applied per unit of depth or reservoir interval length in a wellbore. It should be appreciated that while coverage and volume may be expressed using different physical quantities, both may represent the amount of treatment fluid recommended or otherwise specified. For example, fluid coverage may represent the rate of fluid to be pumped into the wellbore per unit depth or length (e.g., 100 gallons per foot or meter of the wellbore) during a particular stage of the fluid treatment. Fluid volume may represent the actual volume of fluid that is pumped and may be calculated as a product of the fluid coverage and the total treatment length of the particular stage. Thus, if the fluid coverage of the treatment stage in this example is 100 gal/ft. and the overall treatment length is 50 ft., the fluid volume of the stage would be equivalent to 5000 gallons. The relative coverage may represent the ratio between the fluid coverage of this stage relative to the overall fluid coverage across all stages of the treatment. Thus, if the particular stage in this example is one of four treatment stages and the respective fluid coverage values of the three remaining stages are 200, 150 and 300 gal/ft., the relative coverage of the first stage would be equivalent to 100÷(100+200+150+300), or approximately 13.33% of the overall fluid coverage.

As shown in FIG. 4A, different wedge-shaped sections of visualization 400A (e.g., different wedges or sections of the 3D polar graph or pie chart) may be used to represent the treatment parameters for each stage of the fluid treatment design. In an embodiment, the representation of each treatment parameter within a section may be based on a mapping between one or more visualization parameters (e.g., visualization parameters 126 of FIG. 1, as described above) associated with the section and the treatment parameter being represented. The visualization parameters for each section may include, for example and without limitation, a section color, a section angle, a section radius, a section height, a section height shading (e.g., shading along an edge of the section from either bottom-to-top or left-to-right relative to its height), and section text. The section text may be displayed within, for example, an informational textbox or “tool tip” window that appears when the user hovers a selection pointer over the section using a mouse or other pointing device.

The visualization parameters that may be mapped to treatment parameters for each section of visualization 400A include, but are not limited to, a section color 402A, a section radius 404A, a section height 406A, a section height shading 408A and a section angle 410. In the example shown in FIG. 4A, section color 402A is mapped to the stage type, section radius 404A is mapped to the fluid coverage, section height 406A is mapped to the fluid volume score, section height shading 408A is mapped to the material score, and section angle 410 is mapped to the relative coverage. Thus, for the treatment stage in the above-described example that has a 13.33% relative coverage, the value of section angle 410 for this stage may be set to 13.33% of 360 degrees, or 48 degrees. As will be described in further detail below, values assigned to each of these visualization parameters may be used to generate a 3D graphical representation of each section of visualization 400A, as depicted in FIG. 4A.

In an embodiment, an appropriate value may be assigned to each of the above-listed visualization parameters for indicating a relative impact of the corresponding treatment parameter with respect to the design criterion for each stage of the multistage fluid treatment design. The assigned value may be based on, for example, a relative index value or score determined for each of the treatment parameters, as described above. For example, an appropriate length may be assigned to radius 404A for each section of visualization 400A, based on the relative index value/score determined for the fluid coverage parameter determined for that section or corresponding stage of the multistage fluid treatment design represented by that section. Accordingly, the length of radius 404A of each section may be used to indicate the fluid coverage associated with the corresponding stage relative to other stages of the fluid treatment design in this example.

FIG. 4B shows an exemplary 3D single-layered visualization 400B of the multistage fluid treatment design that is similar to visualization 400A of FIG. 4A. However, as noted above, the design criterion represented by visualization 400B is an economic index design criterion rather than the treatment fluid index criterion represented by visualization 400A. The treatment parameters represented by each section of visualization 400B in this example may include, but are not limited to, a stage type, a fluid cost, an additives cost, a relative stage cost and a relative coverage.

As shown in FIG. 4B, the visualization parameters that may be mapped to treatment parameters for each section of visualization 400B include, but are not limited to, a section color 402B, a section radius 404B, a section height 406B, a section height shading 408B and a stage cost 412. In the example shown in FIG. 4B, section color 402B is mapped to the stage type, section radius 404B is mapped to the fluid cost, section height 406B is mapped to the relative stage cost, and section height shading 408B is mapped to the additives cost. Like visualization 400A of FIG. 4A, the angle of each section or wedge of visualization 400B may be mapped to the relative coverage. Stage cost 412 may be mapped to a particular input gesture that can be detected with respect to visualization 400B as it is displayed via the GUI. The input gesture may be, for example, a gesture associated with a particular type of user input device (e.g., a mouse or other pointing device). In the example shown in FIG. 4B, stage cost 412 may be mapped to a hover gesture that is detected when the user uses a mouse or other input device to hover a pointer or cursor over any of the sections of visualization 400B.

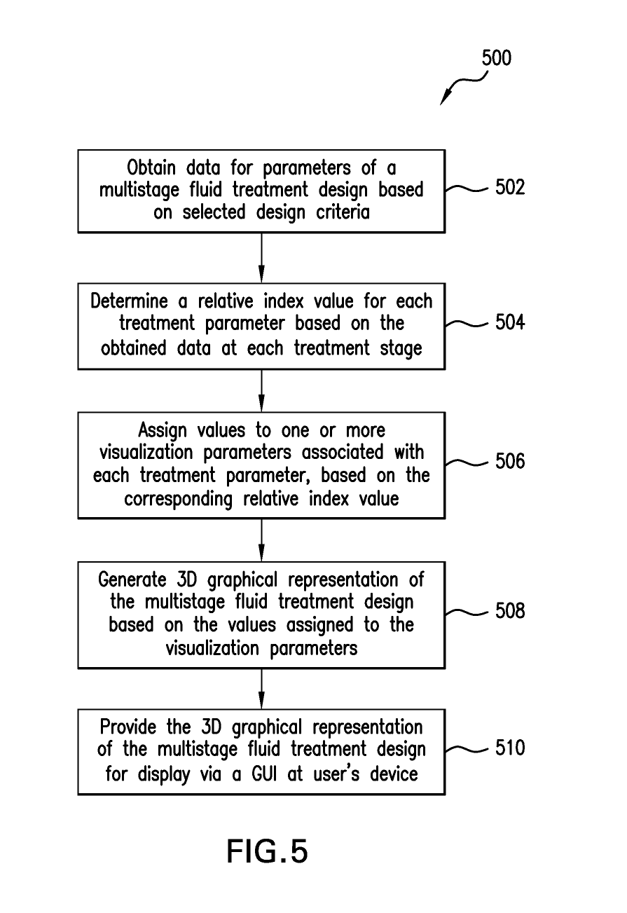

FIG. 5 is a process flowchart of an exemplary method 500 of aiding fluid treatment design and analysis. As shown in FIG. 5, method 500 includes steps 502, 504, 506, 508 and 510. For discussion purposes, method 500 will be described using system 100 of FIG. 1, as described above. However, method 500 is not intended to be limited thereto. For example, the steps of method 500 may be performed by one or more components of treatment design editor 110, as described above.

Method begins in step 502, which includes obtaining data for treatment parameters of a multistage fluid treatment design, based on at least one design criterion selected for consideration from a plurality of design criteria affecting the multistage fluid treatment design. The design criterion may be selected by, for example, a user via a first portion of a GUI (e.g., GUI 130 of FIG. 1, as described above). In an embodiment, the GUI may be for a client application executable at a computing device of the user.

As described above, examples of design criteria that may be selected for consideration in the fluid treatment design include, but are not limited to, a matrix acidizing treatment, being designed include, but are not limited to, a treatment fluids index, an economic index, an additive index, and an environmental index. In an embodiment, the treatment parameters for which the data is obtained may be associated with the particular design criterion that is selected. For example, the treatment parameters for a treatment fluids index criterion may include, but are not limited to, a stage type, a fluid coverage, a fluid volume index or score, a fluid material index/score and a relative coverage of the treatment overall, as described above.

In step 504, the obtained data may be used to determine a relative index value or score for each of the treatment parameters at each stage of the multistage fluid treatment design in this example. In step 506, values may be assigned to one or more visualization parameters for indicating a relative impact of each of the treatment parameters with respect to the selected design factor at each stage of the multistage fluid treatment design, based on the relative index value corresponding to each treatment parameter. A three-dimensional (3D) graphical representation of the multistage fluid treatment design is then generated in step 508, based on the values assigned to the one or more visualization parameters associated with each treatment parameter at each stage of the multistage fluid treatment design. In step 510, the generated 3D graphical representation of the multistage fluid treatment design may be provided for display at the user's device via, for example, a second portion of the GUI described above.

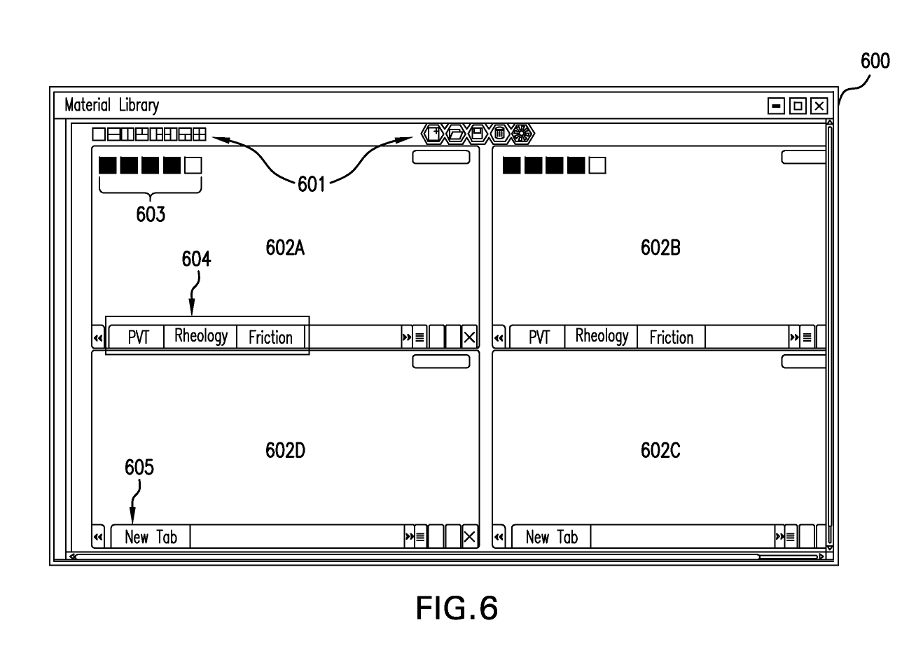

Referring back to FIG. 2, design area 210 may be used to display the different types of 3D visualizations described above for selected treatment design criteria. For example, GUI 200 may provide various controls enabling the user to switch between visualizations 300, 400A and 400B of FIGS. 3, 4A and 4B, respectively. By allowing the user to view in different ways the relative impact of selected criteria of interest at each stage of the fluid treatment design, the above-described multi-dimensional and multi-layered visualization features of GUI 200 may provide the user with an effective tool for analyzing the overall fluid treatment design. As will be described in further detail below, GUI 200 may also provide the user with tools for analyzing different fluids or materials that may be under consideration for use in the fluid treatment design. In an embodiment, such fluid or material analysis tools may be provided by GUI 200 via a material design control 250. The user's selection of material design control 250 may cause a separate material design workspace to be displayed, as shown in FIG. 6.

FIG. 6 is a view of an exemplary design workspace 600 in which the user can view and analyze one or more fluids and related properties that may be under consideration for a fluid treatment design, as described above. In some implementations, design workspace 600 and GUI 200 of FIG. 2 may be provided as different interfaces of a fluid treatment design application executable at the user's computing device, as described above. Alternatively, design workspace 600 may be implemented as a GUI of a separate material library application that is also executable at the user's device. The material library application in this latter case may be initiated or launched, for example, as a result of the user's selection of material design control 250 via GUI 200, as described above.

As shown in FIG. 6, design workspace 600 includes a set of workspace controls 601 and multiple design frames 602A-602D. Each of frames 602A-602D may be, for example, an independent design area for creating or defining new fluid models to be considered for the fluid treatment design in this example. In an embodiment, each fluid model may represent a unique combination of fluids, proppants, other additives and related properties selected by the user for the particular fluid treatment design. As will be described in further detail below, the particular combination of elements that define such a fluid model may be selected by the user through various control panels that are accessible via a set of fluid model design controls 603 provided within each of frames 602A-602D. While only frames 602A-602D are shown in FIG. 6, it should be noted that embodiments are not intended to be limited thereto and that workspace 600 may include additional frames as desired for a particular implementation.

Workspace controls 601 may include various controls for controlling the layout of frames 602A-602D within design workspace 600 and controls for creating a new “workspace” session, saving the current workspace session, including the fluid models associated with each of frames 602A-602D, and opening a previously saved workspace session. Workspace controls 601 may also include controls for deleting a workspace or selected portions (e.g., a selected frame) thereof and for accessing relevant settings (e.g., via a user settings or preference panel) of design workspace 600. Additional controls may also be provided to the user in this example for controlling the number of frames displayed within design workspace 600 as well as the visibility of each frame, e.g., through options to resize, collapse or expand selected frames. Such controls allow the interface of design workspace 600 to be customized as desired by the user.

In an embodiment, multiple fluid models associated with each of frames 602A-602D may be automatically grouped together into a fluid model family. Each fluid model (or family member) within the fluid model family may include a number of fluids (e.g., up to a predetermined maximum) in addition to proppants or user-defined mixed fluids. In an embodiment, each of frames 602A-602D may include a tab control 605 for adding new fluid models to the fluid model family associated with each of frames 602A-602D. Thus, each of frames 602A-602D may include multiple tabs corresponding to different fluid models. The tabs for each frame may be limited to a predetermined number (e.g., maximum of 20 tabs per frame).

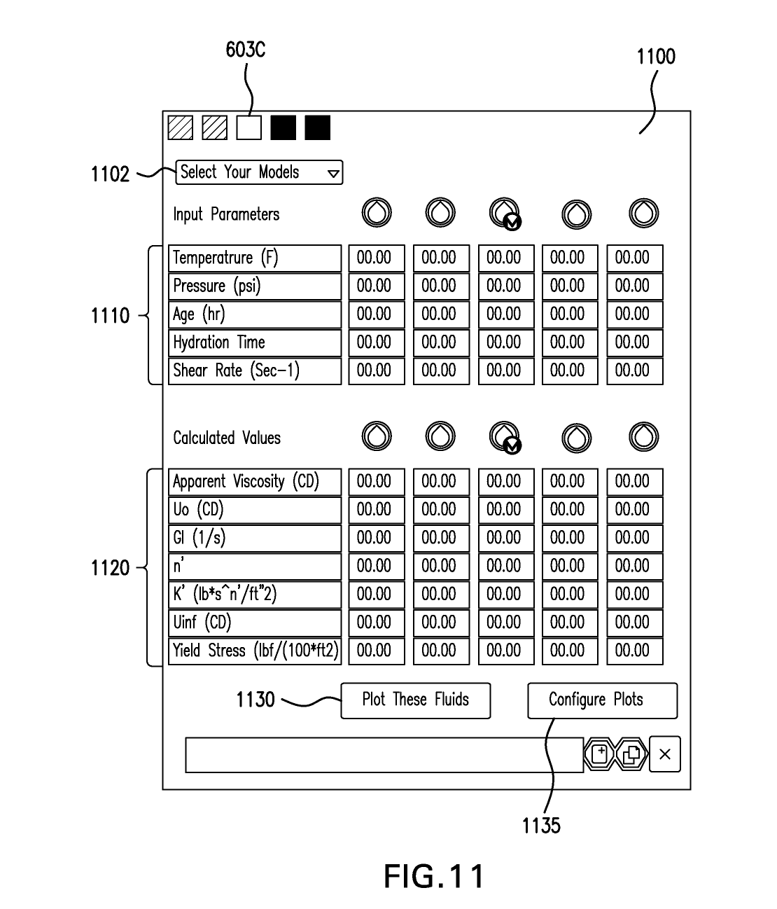

In an embodiment, each of frames 602A-602D may also include a flow model selection control 604 that allows the user to select a particular flow model for performing fluid flow calculations using the fluid models associated with each frame. Examples different types of flow models that may be selected using selection control 604 include, but are not limited to, a fluid pressure-volume-temperature (PVT) model, a rheology model, and a fluid friction model. However, it should be noted that the disclosed embodiments are not intended to be limited thereto and that additional types of flow models may be used as desired for a particular implementation. In an embodiment, each of the flow model options displayed for selection control 604 may have been previously selected and configured by the user via a flow model selection panel, as will be described in further detail below with respect to FIG. 11.

While selection control 604 is shown in FIG. 6 for only frames 602A and 602B, it should be appreciated that frames 602C and 602D may also include similar flow model selection controls. Also, while tab control 605 is shown for only frames 602C and 602D in FIG. 6, it should be appreciated that frames 602A and 602B may include similar tab controls. For example, each of frames 602A-602D may include a menu control including an option to show or hide selected controls, as all of the available controls for each frame may not be visible in the current view of the frame within design workspace 600.

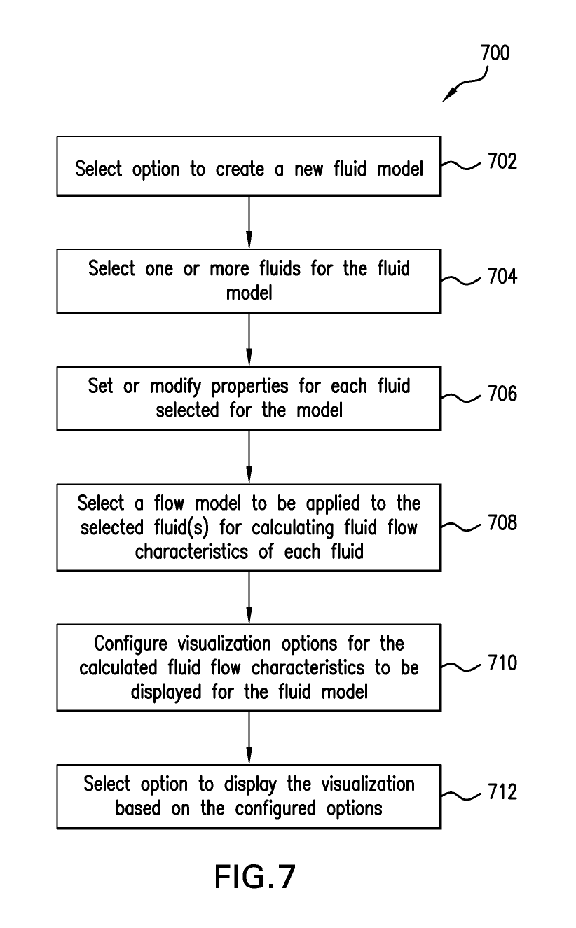

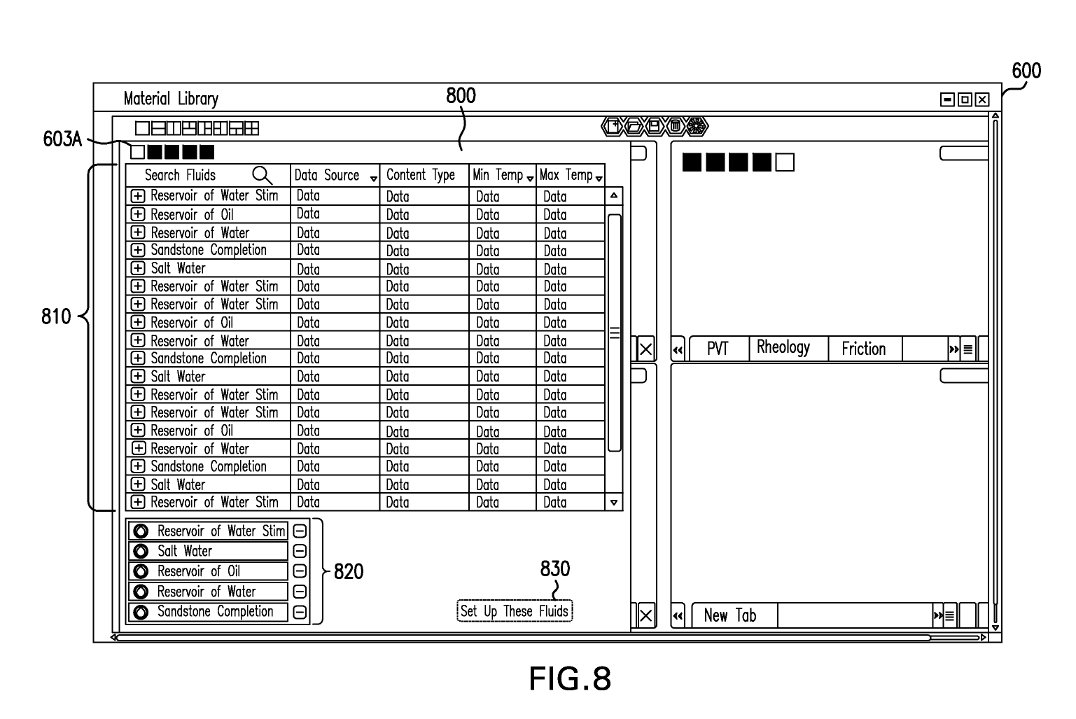

FIG. 7 is a process flowchart of an exemplary user workflow 700 for creating and visualizing a new fluid model for a fluid model family within a particular frame of design workspace 600. For purposes of discussion and explanation, workflow 700 will be described in reference to the exemplary control panels of design workspace 600, as shown in FIGS. 8-13. While these panels are shown in FIGS. 8-13 relative to frame 602A of workspace 600, it should be appreciated that workflow 700 is not intended to be limited thereto and that workflow 700 may be used to create new fluid models for any of frames 602A-602D.

As shown in FIG. 7, workflow 700 begins in step 702, in which an option for creating the new fluid model is selected by the user within the particular frame, e.g., by selecting control 603A within frame 602A of workspace 600. For example, FIG. 8 is a view of an exemplary fluid selection panel 800, which may be displayed relative to frame 602A in response to the user's selection of control 603A. While fluid selection panel 800 is shown in FIG. 8 as a graphical overlay relative to frame 602A within the GUI of design workspace 600, it should be appreciated that the disclosed embodiments are not intended to be limited thereto and that fluid selection panel 800 may be displayed in any of various other ways, e.g., in a separate window or frame of the GUI or within a portion of frame 602A itself.

In step 704, the user may select one or more fluids for the fluid model via, for example, a fluid selection area 810 of fluid selection panel 800. In an embodiment, fluid selection area 810 may be used to display a list of approved materials associated with a particular wellsite operator or oilfield services company. The materials in the list may include various fluids and mixtures thereof. As shown in FIG. 8, the list may be displayed within fluid selection area 810 as a table in which each row represents a different fluid/mixture and each column represents a different attribute of the fluid/mixture. The attributes for each fluid may include, for example and without limitation, a data source, a content type, a minimum temperature, and a maximum temperature.

Thus, the user may select particular fluids by selecting the corresponding rows within fluid selection area 810. In some implementations, the number of fluids that the user can select may be limited to a predetermined maximum, e.g., up to five different fluids for a single fluid model. The fluids selected by the user via fluid selection area 810 may be added to a separate list of selected fluids displayed within an area 820 of fluid selection panel 800. Each fluid in the list may be displayed within area 820 with a control button that the user can select to deselect or remove the fluid from the list.

In step 706, the user may set or modify properties for each selected fluid by interacting with appropriate columns in the corresponding row displayed for the fluid within fluid selection area 810. For example, the user may select a particular fluid by selecting the corresponding row within fluid selection area 810 and set or modify properties for the fluid by interacting with a user control displayed for each property within different columns of the table in fluid selection area 810. Such user interaction may involve, for example, entering values into a text field or selecting an option from a list control displayed at the intersection of a row and a column of the table within fluid selection area 810.

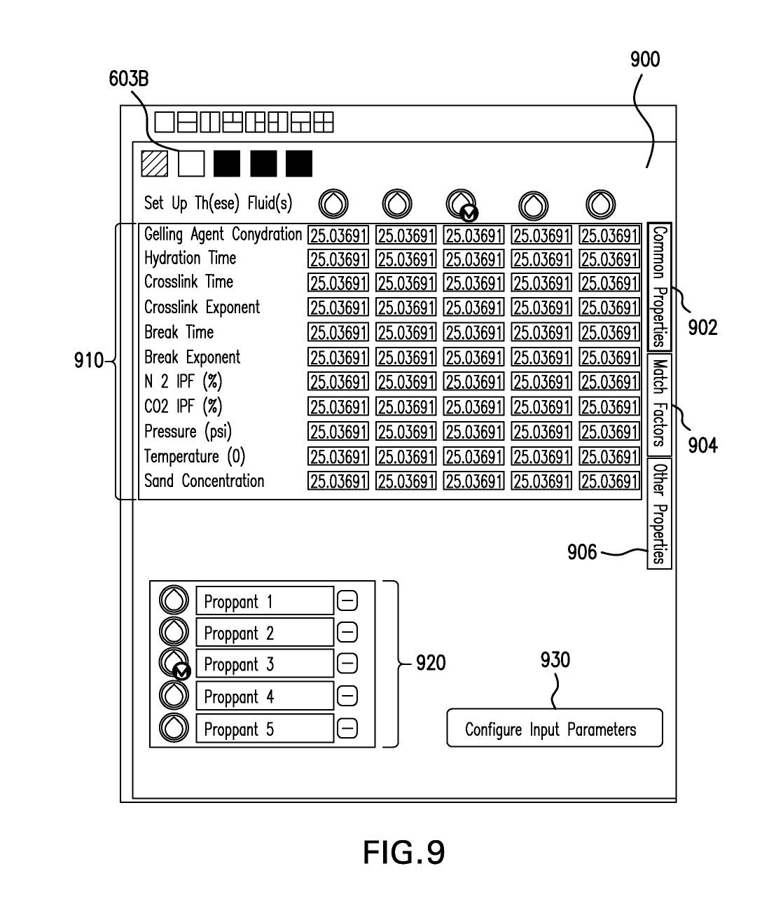

In an embodiment, fluid selection panel 800 may also provide the user with an option to set up or calibrate additional properties for one or more of the fluids selected from area 810 and included within the list in area 820. In one example, the user may choose one or more fluids from the list displayed within area 820 and select a control button 830 of panel 800 to access a separate panel of design workspace 600 for calibrating various common properties, match factors and other relevant properties associated with each fluid, as will described in further detail below with respect to FIG. 9. Such a fluid calibration panel may also be accessible to the user via a control 603B displayed within a frame, e.g., frame 602A, of workspace 600, as shown in FIG. 9.

FIG. 9 is a view of an exemplary fluid calibration panel 900 for configuring or calibrating one or more fluid(s) and associated properties for a fluid model. Fluid calibration panel 900 may be displayed, for example, in response to the user's selection of either control button 830 or control 603B. Similar to fluid selection panel 800 of FIG. 8, fluid calibration panel 900 may be displayed as a graphical overlay relative to frame 602A within design workspace 600, e.g., in place of fluid selection panel 800.

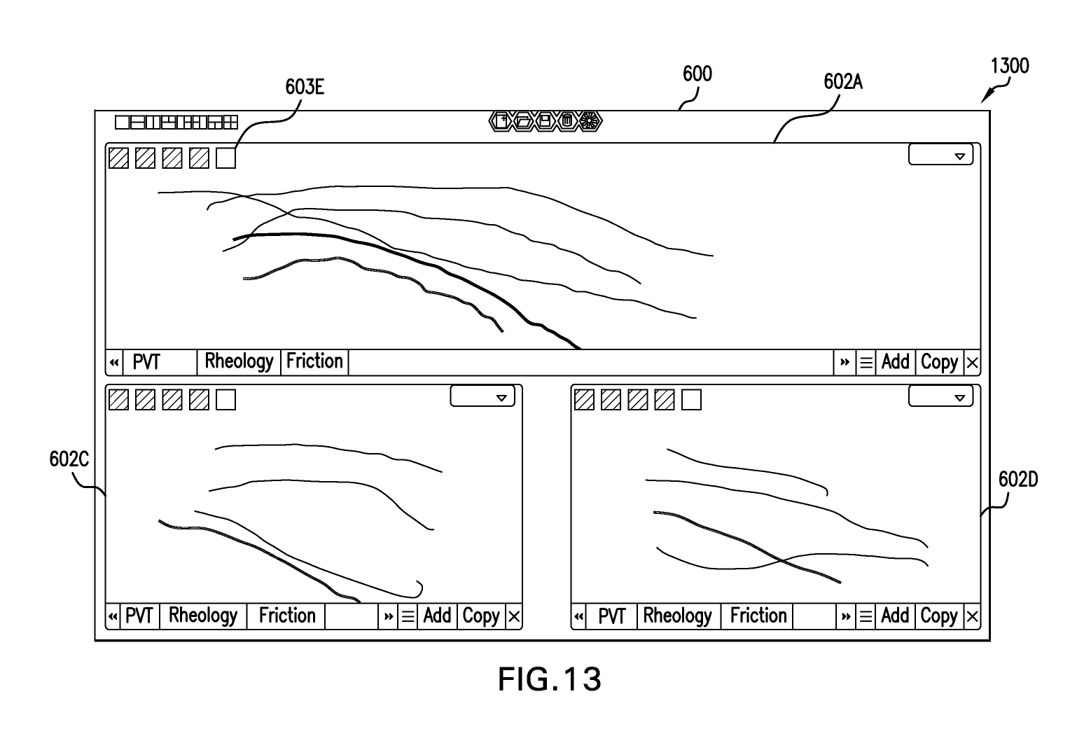

In an embodiment, fluid calibration panel 900 may provide the user with options for modifying various fluid parameters including, for example, common properties 902, match factors 904, and other relevant properties 906 for the selected fluid(s) being calibrated. Match factors 904 may be, for example, a list of multipliers that can be applied to “tweak” a fluid's calculated properties by increasing or decreasing a particular property value as desired. This may be useful in constructing a user-defined fluid with properties that match actual measurements. Such multipliers may include any of various adjustable factors that can impact the material properties of the fluid and visualization thereof. For example, a “Base Friction Multiplier” option (not shown) may be provided as one of match factors 904 within fluid calibration panel 900 that can be adjusted either up (increased) or down (decreased) in order to generate a new set of friction data for the fluid to be visualized within design workspace 600, as will be described in further detail below with respect to FIG. 13. Other examples of multipliers that may be provided as match factors 904 include, but are not limited to, multipliers for pressure, temperature, mass, density, and different concentrations of materials in the fluid. An area 910 of fluid calibration panel 900 may be used to display predetermined or default values for the selected parameters associated with each fluid. In the example shown in FIG. 9, area 910 displays the values for a list of common properties 902 in separate columns corresponding to the different fluids previously selected by the user, e.g., via area 810 or 820 of fluid selection panel 800, as described above.

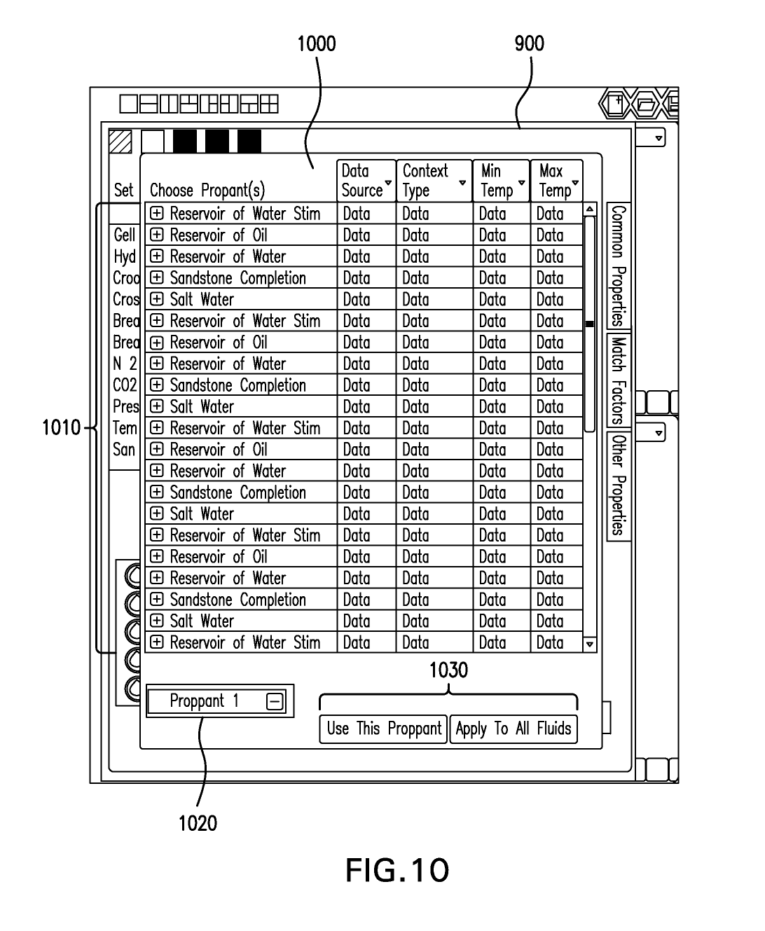

In an embodiment, the user may also have the option of selecting a proppant to be associated with each of the fluids displayed within area 910. The proppant for each fluid may be selected from a list of available proppants displayed within a separate panel or window, e.g., as a separate overlay relative to fluid calibration panel 900, as shown in FIG. 10. FIG. 10 is a view of an exemplary proppant selection panel 1000 including an area 1010 for displaying a list of proppants that may be selected by the user for a particular fluid being calibrated via fluid calibration panel 900 of FIG. 9. For example, proppant selection panel 1000 may be accessible from fluid calibration panel 900, e.g., via a separate user control (not shown) within panel 900. Alternatively, proppant selection panel 1000 may be displayed automatically in response to input from the user with respect to one of the common properties 902 of the fluid being calibrated that directly affects the list of available proppants that may be used in combination with that fluid. For example, the user may trigger the display of proppant selection panel 1000 by modifying values of the “Sand Concentration” property for one of the fluids within area 910 of fluid calibration panel 900.

The user may interact with area 1010 of proppant selection panel 1000 to select a particular proppant from the list of proppants displayed therein. As shown in FIG. 10, the selected proppant may be displayed in an area 1020 of proppant selection panel 1000. Also, as shown in FIG. 10, proppant selection panel 1000 may include a set of control buttons 1030 that provide the user with an option to either use the selected proppant for the particular fluid or apply the selected proppant to all of the fluids being calibrated within fluid calibration panel 900 of FIG. 9. Referring back to FIG. 9, the proppant selected for each fluid via proppant selection panel 1000 may be added to a selected proppants list displayed within an area 920 of fluid calibration panel 900.

Referring further back to FIG. 7, once the user has selected proppants and calibrated properties of the fluids selected for the fluid model, the user may proceed to step 708 of workflow 700. Step 708 includes selecting a flow model to be applied to the selected fluids for calculating fluid flow characteristics of the fluid model being created. The flow model may be selected by the user from a list of different types of flow models displayed within a flow model selection panel, as shown in FIG. 11.

FIG. 11 is a view of an exemplary flow model selection panel 1100 for selecting and configuring a particular type of flow model to be applied to each fluid selected for the fluid model. Similar to fluid selection panel 800 and fluid calibration panel 900 of FIGS. 8 and 9, respectively, flow model selection panel 1100 may be displayed as a graphical overlay relative to frame 602A within design workspace 600, e.g., in place of the previously displayed fluid calibration panel 900. Flow model selection panel 1100 may be displayed, for example, in response to the user's selection of either control button 930 of fluid calibration panel 900 or control 603C of frame 602A.

As shown in FIG. 11, flow model selection panel 1100 includes a flow model selector 1102 that the user can use to select the type of flow model from a list of different flow model types. For example, the user may select one type of flow model to be applied to all of the selected fluids. Alternatively, the user may select a different type flow model for each of the selected fluids. While flow model selector 1102 is shown as a list control in FIG. 11, it should be appreciated that any of various types of controls may be used as desired for a particular implementation. As noted previously, examples of different flow model types that may be available for selection by the user include, but are not limited to, a fluid pressure-volume-temperature (PVT) model, a rheology model, and a fluid friction model. Once a flow model has been selected via flow model selector 1102, the user can modify various input parameters 1110 of the selected flow model for each selected fluid to be included in the fluid model. In an embodiment, the values of input parameters 1110 and the selected flow model type are used to calculate values representing a set of flow characteristics 1120 for each fluid selected for the fluid model.

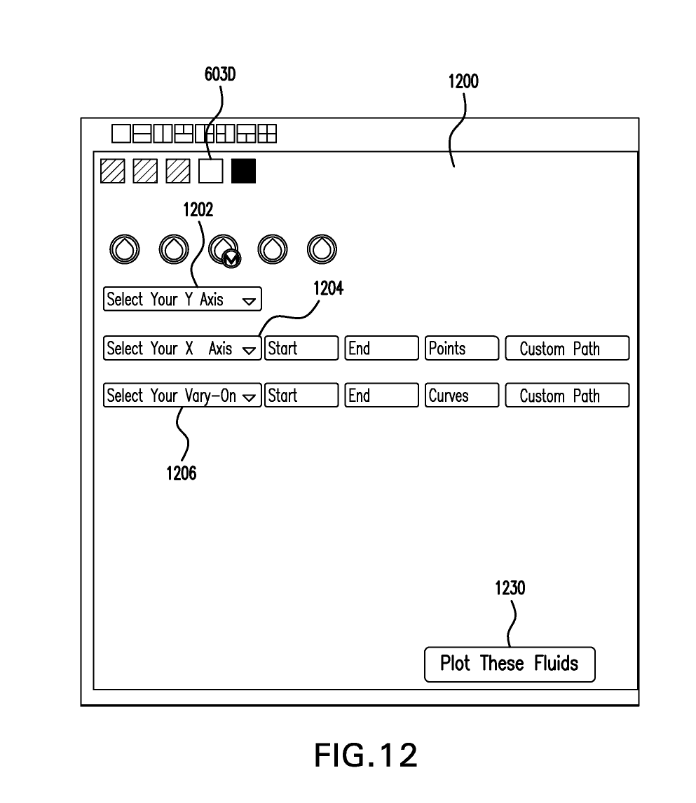

Referring back to FIG. 7, the user may proceed to step 710 of workflow 700, in which the user may configure different options for a visualization of the calculated flow characteristics 1120 to be displayed within design workspace 600. The visualization options may be configured by the user via a visualization options panel 1200, as shown in FIG. 12. Similar to the other panels of design workspace 600, visualization options panel 1200 may be displayed as a graphical overlay relative to frame 602A, e.g., in place of the previously displayed flow model selection panel 1100. For example, visualization options panel 1200 may be accessed by the user from flow model selection panel 1100, e.g., via a control button 1130 or a control 603D associated with frame 602A. The different options provided within visualization options panel 1200 may allow the user to customize appropriate display parameters for the type of visualization to be displayed.

In an embodiment, the visualization of the calculated flow characteristics 1120 may be in the form of a cross-plot or line graph. Accordingly, the visualization options that may be configured by the user in this example include options for selecting appropriate parameters and variables for the x-axis and y-axis of the graph. Such options may be provided to the user through various selection controls 1202, 1204 and 1206 displayed within visualization options panel 1200, as shown in FIG. 12. For example, selection control 1202 may be used to select an appropriate y-axis for the graph, e.g., from a list of available options for the particular set of fluids. Similarly, selection control 1204 may be used to select an appropriate x-axis for the graph. Options for the y-axis may include, for example, any of the calculated fluid flow characteristics for each selected flow model type. Options for the x-axis may include, for example, different properties of the selected fluids or states thereof. Selection control 1206 may be used, for example, to select the type of line graph that is visualized. However, it should be noted that the disclosed embodiments are not intended to be limited to the visualization options shown in FIG. 12 and that additional visualization options may be included, as desired for a particular implementation. Such additional visualization options may include, but are not limited to, options for customizing or selecting different color schemes for the graph and generating different types of graphs or reports based on the graph data.

Referring back to FIG. 7, once the visualization options are configured by the user (in step 710) through visualization options panel 1200, as described above, the user may proceed to step 712 of workflow 700 in which the user selects an option to display the visualization based on the configured options. Such an option may be provided to the user within visualization options panel 1200, for example, as a control button 1230 that may be selected by the user to display the cross-plot or line graph visualization in this example. Additionally or alternatively, the user may select a control 603E within the set of fluid design controls 603 associated with a frame, e.g., frame 602A, of design workspace 600, as shown in FIG. 13. While the visualization in this example is described in the context of representing different fluids selected for a fluid model created within each frame, it should be appreciated that the visualization techniques disclosed herein may be extended to cover multiple models within each frame (or model family thereof) and across multiple tabs in a single frame.

FIG. 13 is an exemplary a view 1300 of design workspace 600 of FIG. 6, in which the calculated flow characteristics are visualized for different fluid models within frames 602A, 602C and 602D. While only frames 602A, 602C and 602D are shown in the example of FIG. 13, it should be appreciated that visualizations of flow characteristics for additional fluid models and frames, including frame 602B, may also be displayed. The visualization displayed within each frame may use different colors to distinguish between the different fluids and/or fluid models that are visualized.

Referring back again to FIG. 7, the fluid model created through workflow 700 may be associated with a particular frame, e.g., 602A, of design workspace 600. As described above, each frame may represent a fluid model family including a number of individual fluid models (or family members), for example, up to a predetermined maximum number, e.g., up to five models, within each model family. The members of a fluid model family may be automatically linked or associated with each other and with the particular frame in which it was created or to which it was added. In an embodiment, the user may interact with the individual fluid models within each frame in order to move previously linked family members to different frames, e.g., for comparison purposes, while still maintaining the data link between the moved family member and other members of the family. In a further embodiment, the user may also be able to delink family members in order to modify existing families or create new ones. For example, design workspace 600 may allow the user via a user input device to simply drag and drop selected fluid models into different frames. The visualization for each fluid model displayed within design workspace 600, as shown in view 1300 of FIG. 13, may be automatically updated according to the modifications made by the user.

A benefit of the above-describes techniques is that it allows users to simultaneously visualize and compare multiple fluid models across multiples frames and tabs within each frame of the design workspace. As the fluid models are automatically associated with different fluid model families within the respective frames, users can easily modify such associations as desired based on the comparison. By enabling users to view multiple graphical visualizations of fluid model data within the same workspace, the comparison and decision making process becomes more readily accessible and avoids having to create output screenshots and switch between the model creation workflow and the resulting data. This also helps users, such as reservoir engineers, to compare and assess different materials more effectively using fewer steps and with the added benefit of storing the resulting data for future consumption, distribution or modification.

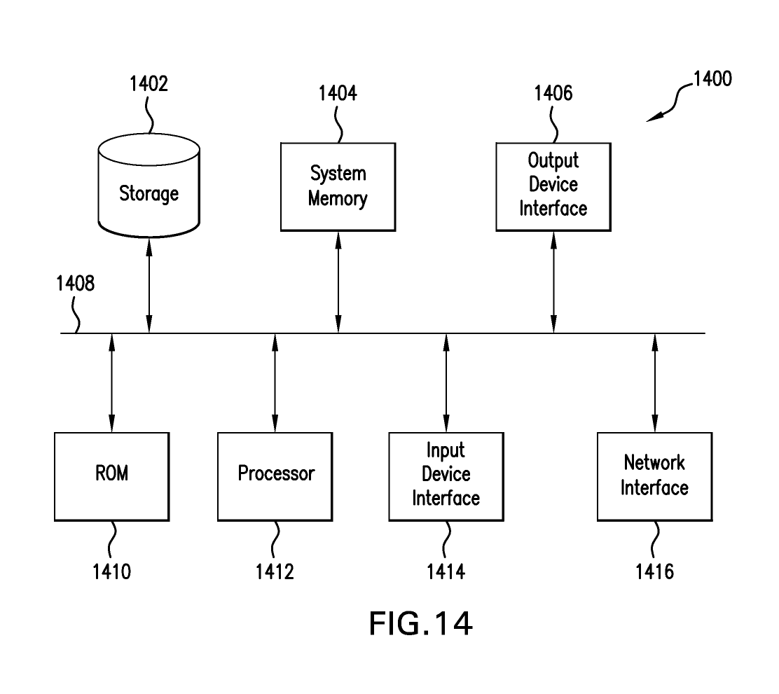

FIG. 14 is a block diagram of an exemplary computer system 1400 in which embodiments of the present disclosure may be implemented. For example, system 100 of FIG. 1, as described above, may be implemented using system 1400. System 1400 can be a computer, phone, PDA, or any other type of electronic device. Such an electronic device includes various types of computer readable media and interfaces for various other types of computer readable media. As shown in FIG. 14, system 1400 includes a permanent storage device 1402, a system memory 1404, an output device interface 1406, a system communications bus 1408, a read-only memory (ROM) 1410, processing unit(s) 1412, an input device interface 1414, and a network interface 1416.

Bus 1408 collectively represents all system, peripheral, and chipset buses that communicatively connect the numerous internal devices of system 1400. For instance, bus 1408 communicatively connects processing unit(s) 1412 with ROM 1410, system memory 1404, and permanent storage device 1402.

From these various memory units, processing unit(s) 1412 retrieves instructions to execute and data to process in order to execute the processes of the subject disclosure. The processing unit(s) can be a single processor or a multi-core processor in different implementations.

ROM 1410 stores static data and instructions that are needed by processing unit(s) 1412 and other modules of system 1400. Permanent storage device 1402, on the other hand, is a read-and-write memory device. This device is a non-volatile memory unit that stores instructions and data even when system 1400 is off Some implementations of the subject disclosure use a mass-storage device (such as a magnetic or optical disk and its corresponding disk drive) as permanent storage device 1402.

Other implementations use a removable storage device (such as a floppy disk, flash drive, and its corresponding disk drive) as permanent storage device 1402. Like permanent storage device 1402, system memory 1404 is a read-and-write memory device. However, unlike storage device 1402, system memory 1404 is a volatile read-and-write memory, such a random access memory. System memory 1404 stores some of the instructions and data that the processor needs at runtime. In some implementations, the processes of the subject disclosure are stored in system memory 1404, permanent storage device 1402, and/or ROM 1410. For example, the various memory units include instructions for computer aided pipe string design based on existing string designs in accordance with some implementations. From these various memory units, processing unit(s) 1412 retrieves instructions to execute and data to process in order to execute the processes of some implementations.

Bus 1408 also connects to input and output device interfaces 1414 and 1406. Input device interface 1414 enables the user to communicate information and select commands to the system 1400. Input devices used with input device interface 1414 include, for example, alphanumeric, QWERTY, or T9 keyboards, microphones, and pointing devices (also called “cursor control devices”). Output device interfaces 1406 enables, for example, the display of images generated by the system 1400. Output devices used with output device interface 1406 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 14, bus 1408 also couples system 1400 to a public or private network (not shown) or combination of networks through a network interface 1416. Such a network may include, for example, a local area network (“LAN”), such as an Intranet, or a wide area network (“WAN”), such as the Internet. Any or all components of system 1400 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, the steps of methods 500 and 700 of FIGS. 5 and 7, respectively, as described above, may be implemented in the form of instructions executable by system 1400 or any computer system having processing circuitry or a computer program product including such instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the exemplary methodologies described herein may be implemented by a system including processing circuitry or a computer program product including instructions which, when executed by at least one processor, causes the processor to perform any of the methodology described herein.

As described above, a computer-implemented method of aiding fluid treatment design and analysis may include: obtaining data for treatment parameters associated with a multistage fluid treatment design, based on at least one design criterion selected for consideration from a plurality of design criteria affecting the multistage fluid treatment design; determining a relative index value for each of the treatment parameters with respect to the selected design criterion at each stage of the multistage fluid treatment design, based on the obtained data; assigning values to one or more visualization parameters for indicating a relative impact of each of the treatment parameters with respect to the selected design criterion at each stage of the multistage fluid treatment design, based on the relative index value corresponding to each treatment parameter; generating a three-dimensional (3D) graphical representation of the multistage fluid treatment design, based on the values assigned to the one or more visualization parameters for each of the treatment parameters associated with the selected design criterion for each stage of the multistage fluid treatment design; and providing the 3D graphical representation of the multistage fluid treatment design for display via a graphical user interface (GUI) of a client application executable at a computing device of a user. Furthermore, a computer-readable storage medium having instructions stored therein is described, and when the instructions are executed by a computer, they cause the computer to perform a plurality of functions, including functions to: obtain data for treatment parameters associated with a multistage fluid treatment design, based on at least one design criterion selected for consideration from a plurality of design criteria affecting the multistage fluid treatment design; determine a relative index value for each of the treatment parameters with respect to the selected design criterion at each stage of the multistage fluid treatment design, based on the obtained data; assign values to one or more visualization parameters for indicating a relative impact of each of the treatment parameters with respect to the selected design criterion at each stage of the multistage fluid treatment design, based on the relative index value corresponding to each treatment parameter; generate a three-dimensional (3D) graphical representation of the multistage fluid treatment design, based on the values assigned to the one or more visualization parameters for each of the treatment parameters associated with the selected design criterion for each stage of the multistage fluid treatment design; and provide the 3D graphical representation of the multistage fluid treatment design for display to a user via a graphical user interface (GUI) of a client application executable by the computer.

Also, as described above, a system for fluid treatment design and analysis may include at least one processor and a memory coupled to the processor having instructions stored therein, which when executed by the processor, cause the processor to perform functions including functions to: obtain data for treatment parameters associated with a multistage fluid treatment design, based on at least one design criterion selected for consideration from a plurality of design criteria affecting the multistage fluid treatment design; determine a relative index value for each of the treatment parameters with respect to the selected design criterion at each stage of the multistage fluid treatment design, based on the obtained data; assign values to one or more visualization parameters for indicating a relative impact of each of the treatment parameters with respect to the selected design criterion at each stage of the multistage fluid treatment design, based on the relative index value corresponding to each treatment parameter; generate a three-dimensional (3D) graphical representation of the multistage fluid treatment design, based on the values assigned to the one or more visualization parameters for each of the treatment parameters associated with the selected design criterion for each stage of the multistage fluid treatment design; and provide the 3D graphical representation of the multistage fluid treatment design for display to a user via a graphical user interface (GUI) of a client application executable by the computer.

For the foregoing embodiments, the obtained data may include at least one of a pumping schedule or downhole environment information associated with one or more wellbores drilled into a subsurface reservoir formation targeted for stimulation by fluid injection treatment. Also, the downhole environment information may include one or more of wellbore dimensions, wellbore fluids, reservoir layer types and wellbore locations. The plurality of design criteria for the multistage fluid treatment design may be displayed within a first portion of the GUI that enables the user to select one or more of the plurality of design criteria, and the generated 3D graphical representation of the multistage fluid treatment design is presented within a second portion of the GUI. Further, the foregoing embodiments may include any one of the following functions, operations or elements, either alone or in combination with each other: receiving input from the user selecting two or more of the plurality of design criteria via the first portion of the GUI; and determining the treatment parameters for the multistage fluid treatment design based on each of the two or more design criteria selected by the user via the first portion of the GUI.

The plurality of design criteria may include a treatment fluids index, an economic index, an additive index, and an environmental index. The treatment parameters for the treatment fluids index criterion may include a stage type, a fluid coverage, a fluid volume index or score, a fluid material index or score, and a relative coverage of the multistage fluid treatment design overall, and the treatment parameters for the economic index criterion may include a stage type, a fluid cost, an additives cost, a relative stage cost and a relative coverage. The 3D graphical representation presented within the second portion of the GUI may be a 3D polar graph including a plurality of sections corresponding to different stages of the multistage fluid treatment design, and the visualization parameters may include a section color, a section angle, a section radius, a section height, a section height shading, and section text for each of the plurality of sections of the 3D polar graph. Each section of the 3D polar graph may be used to represent the treatment parameters for a corresponding stage of the multistage fluid treatment design, and each of the visualization parameters for each section of the 3D polar graph may be mapped to at least one of the treatment parameters for each design criterion selected by the user via the first portion of the GUI. The above-described obtaining, determining and assigning functions or operations may be repeated for each of the two or more design criteria selected by the user via the first portion of the GUI, and the 3D graphical representation presented within the second portion of the GUI may include multiple layers corresponding to the two or more design criteria.

Furthermore, in any of the foregoing embodiments, the GUI may include a fluid design workspace for defining one or more fluid models for the multistage fluid treatment design. The one or more fluid models may be grouped within a fluid model family associated with a specified frame of the fluid design workspace, as described above. The functions or operations may further include functions to: receive input from the user selecting one or more fluids and associated fluid properties for a new fluid model to be added to the fluid model family via the specified frame of the fluid design workspace; receive input from the user selecting at least one flow model to be applied to the selected one or more fluids of the new fluid model; calculate flow characteristics of each of the one or more fluids selected by the user based on the selected flow model; and provide a graphical representation of the calculated flow characteristics for each of the one or more fluids within the specified frame of the fluid based on visualization options selected by the user via a visualization options panel of the fluid design workspace. The visualization options panel may be one of a plurality of panels provided to the user for selecting different options for various fluid models and related fluid model families within the fluid design workspace, and the specified frame is one of a plurality of frames for defining the various fluid models and related fluid model families. Each of the plurality of panels may be displayed as a graphical overlay relative to at least one of the plurality of frames specified by the user via the fluid design workspace. The aforementioned flow model may be selected from the group consisting of: a fluid pressure-volume-temperature (PVT) model, a rheology model, and a fluid friction model.

While specific details about the above embodiments have been described, the above hardware and software descriptions are intended merely as example embodiments and are not intended to limit the structure or implementation of the disclosed embodiments. For instance, although many other internal components of the system 1400 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the figures illustrate the architecture, functionality, and operation of possible implementations of systems, methods and computer program products according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the embodiments in the form disclosed. Many modifications and variations will be apparent to those of ordinary skill in the art without departing from the scope and spirit of the disclosure. The illustrative embodiments described herein are provided to explain the principles of the disclosure and the practical application thereof, and to enable others of ordinary skill in the art to understand that the disclosed embodiments may be modified as desired for a particular implementation or use. The scope of the claims is intended to broadly cover the disclosed embodiments and any such modification.

What is claimed is:

1. A computer-implemented method of aiding fluid treatment design and analysis, the method comprising:
obtaining data for treatment parameters associated with a multistage fluid treatment design, based on at least one design criterion selected for consideration from a plurality of design criteria affecting the multistage fluid treatment design;
determining a relative index value for each of the treatment parameters with respect to the selected design criterion at each stage of the multistage fluid treatment design, based on the obtained data;
assigning values to one or more visualization parameters for indicating a relative impact of each of the treatment parameters with respect to the selected design criterion at each stage of the multistage fluid treatment design, based on the relative index value corresponding to each treatment parameter;
generating a three-dimensional (3D) graphical representation of the multistage fluid treatment design, based on the values assigned to the one or more visualization parameters for each of the treatment parameters associated with the selected design criterion for each stage of the multistage fluid treatment design; and
providing the 3D graphical representation of the multistage fluid treatment design for display via a graphical user interface (GUI) of a client application executable at a computing device of a user.

2. The method of claim 1, wherein the obtained data includes at least one of a pumping schedule or downhole environment information associated with one or more wellbores drilled into a subsurface reservoir formation targeted for stimulation by fluid injection treatment.

3. The method of claim 2, wherein the downhole environment information includes one or more of wellbore dimensions, wellbore fluids, reservoir layer types and wellbore locations.

4. The method of claim 1, wherein the plurality of design criteria for the multistage fluid treatment design is displayed within a first portion of the GUI that enables the user to select one or more of the plurality of design criteria, and the generated 3D graphical representation of the multistage fluid treatment design is presented within a second portion of the GUI.

5. The method of claim 4, wherein obtaining further comprises:
receiving input from the user selecting two or more of the plurality of design criteria via the first portion of the GUI; and
determining the treatment parameters for the multistage fluid treatment design based on each of the two or more design criteria selected by the user via the first portion of the GUI.

6. The method of claim 5, wherein the plurality of design criteria include a treatment fluids index, an economic index, an additive index, and an environmental index.

7. The method of claim 6, wherein the treatment parameters for the treatment fluids index criterion include a stage type, a fluid coverage, a fluid volume index or score, a fluid material index or score, and a relative coverage of the multistage fluid treatment design overall, and the treatment parameters for the economic index criterion include a stage type, a fluid cost, an additives cost, a relative stage cost and a relative coverage.

8. The method of claim 7, wherein the 3D graphical representation presented within the second portion of the GUI is a 3D polar graph including a plurality of sections corresponding to different stages of the multistage fluid treatment design, and the visualization parameters include a section color, a section angle, a section radius, a section height, a section height shading, and section text for each of the plurality of sections of the 3D polar graph.

9. The method of claim 8, wherein each section of the 3D polar graph is used to represent the treatment parameters for a corresponding stage of the multistage fluid treatment design, and each of the visualization parameters for each section of the 3D polar graph is mapped to at least one of the treatment parameters for each design criterion selected by the user via the first portion of the GUI.

10. The method of claim 8, wherein the obtaining, the determining and the assigning are repeated for each of the two or more design criteria selected by the user via the first portion of the GUI, and the 3D graphical representation presented within the second portion of the GUI includes multiple layers corresponding to the two or more design criteria.

11. A system for fluid treatment design and analysis, the system comprising:
at least one processor; and
a memory coupled to the processor having instructions stored therein, which when executed by the processor, cause the processor to perform functions including functions to:
obtain data for treatment parameters associated with a multistage fluid treatment design, based on at least one design criterion selected for consideration from a plurality of design criteria affecting the multistage fluid treatment design;
determine a relative index value for each of the treatment parameters with respect to the selected design criterion at each stage of the multistage fluid treatment design, based on the obtained data;
assign values to one or more visualization parameters for indicating a relative impact of each of the treatment parameters with respect to the selected design criterion at each stage of the multistage fluid treatment design, based on the relative index value corresponding to each treatment parameter;
generate a three-dimensional (3D) graphical representation of the multistage fluid treatment design, based on the values assigned to the one or more visualization parameters for each of the treatment parameters associated with the selected design criterion for each stage of the multistage fluid treatment design; and
provide the 3D graphical representation of the multistage fluid treatment design for display to a user via a graphical user interface (GUI) of a client application executable by the processor.

12. The system of claim 11, wherein the obtained data includes at least one of a pumping schedule or downhole environment information associated with one or more wellbores drilled into a subsurface reservoir formation targeted for stimulation by fluid injection treatment.

13. The system of claim 12, wherein the downhole environment information includes one or more of wellbore dimensions, wellbore fluids, reservoir layer types and wellbore locations.

14. The system of claim 11, wherein the plurality of design criteria for the multistage fluid treatment design is displayed within a first portion of the GUI that enables the user to select one or more of the plurality of design criteria, and the generated 3D graphical representation of the multistage fluid treatment design is presented within a second portion of the GUI.

15. The system of claim 14, wherein the functions performed by the processor further include functions to:
receive input from the user selecting two or more of the plurality of design criteria via the first portion of the GUI; and
determine the treatment parameters for the multistage fluid treatment design based on each of the two or more design criteria selected by the user via the first portion of the GUI.

16. The system of claim 15, wherein the plurality of design criteria include a treatment fluids index, an economic index, an additive index, and an environmental index.

17. The system of claim 16, wherein the treatment parameters for the treatment fluids index criterion include a stage type, a fluid coverage, a fluid volume index or score, a fluid material index or score, and a relative coverage of the multistage fluid treatment design overall, and the treatment parameters for the economic index criterion include a stage type, a fluid cost, an additives cost, a relative stage cost and a relative coverage.

18. The system of claim 7, wherein the 3D graphical representation presented within the second portion of the GUI is a 3D polar graph including a plurality of sections corresponding to different stages of the multistage fluid treatment design, and the visualization parameters include a section color, a section angle, a section radius, a section height, a section height shading, and section text for each of the plurality of sections of the 3D polar graph.

19. The system of claim 8, wherein each section of the 3D polar graph is used to represent the treatment parameters for a corresponding stage of the multistage fluid treatment design, and each of the visualization parameters for each section of the 3D polar graph is mapped to at least one of the treatment parameters for each design criterion selected by the user via the first portion of the GUI.

20. A computer-readable storage medium having instructions stored therein, which when executed by a computer cause the computer to perform a plurality of functions, including functions to:
obtain data for treatment parameters associated with a multistage fluid treatment design, based on at least one design criterion selected for consideration from a plurality of design criteria affecting the multistage fluid treatment design;
determine a relative index value for each of the treatment parameters with respect to the selected design criterion at each stage of the multistage fluid treatment design, based on the obtained data;
assign values to one or more visualization parameters for indicating a relative impact of each of the treatment parameters with respect to the selected design criterion at each stage of the multistage fluid treatment design, based on the relative index value corresponding to each treatment parameter;
generate a three-dimensional (3D) graphical representation of the multistage fluid treatment design, based on the values assigned to the one or more visualization parameters for each of the treatment parameters associated with the selected design criterion for each stage of the multistage fluid treatment design; and
provide the 3D graphical representation of the multistage fluid treatment design for display to a user via a graphical user interface (GUI) of a client application executable by the computer.

21. The computer-readable storage medium of claim 20, wherein the GUI includes a fluid design workspace for defining one or more fluid models for the multistage fluid treatment design.

22. The computer-readable storage medium of claim 21, wherein the one or more fluid models are grouped within a fluid model family associated with a specified frame of the fluid design workspace.

23. The computer-readable storage medium of claim 22, wherein the plurality of functions performed by the computer further include functions to:
receive input from the user selecting one or more fluids and associated fluid properties for a new fluid model to be added to the fluid model family via the specified frame of the fluid design workspace;
receive input from the user selecting at least one flow model to be applied to the selected one or more fluids of the new fluid model; and
calculate flow characteristics of each of the one or more fluids selected by the user based on the selected flow model.

24. The computer-readable storage medium of claim 23, wherein the flow model is selected from the group consisting of: a fluid pressure-volume-temperature (PVT) model, a rheology model, and a fluid friction model.

25. The computer-readable storage medium of claim 23, wherein the plurality of functions performed by the computer further include functions to:
provide a graphical representation of the calculated flow characteristics for each of the one or more fluids within the specified frame of the fluid based on visualization options selected by the user via a visualization options panel of the fluid design workspace.

26. The computer-readable storage medium of claim 25, wherein the visualization options panel is one of a plurality of panels provided to the user for selecting different options for various fluid models and related fluid model families within the fluid design workspace, and the specified frame is one of a plurality of frames for defining the various fluid models and related fluid model families.

27. The computer-readable storage medium of claim 26, wherein each of the plurality of panels is displayed as a graphical overlay relative to at least one of the plurality of frames specified by the user via the fluid design workspace.
